(19) United States
(12) Patent Application Publication
(10) Pub. No.: US 2025/0252315 A1
(43) Pub. Date: Aug. 7, 2025

(54) REINFORCEMENT LEARNING METHOD AND SYSTEM BASED ON SEQUENTIAL DECISION-MAKING, DEVICE, AND MEDIUM

(71) Applicants: University of Electronic Science and Technology of China, Chengdu (CN); Sichuan Digital Economy Research Institute (Yibin), Yibin (CN)

(72) Inventors: Ning XIE, Chengdu (CN); Jiaming LI, Chengdu (CN); Haolan TANG, Chengdu (CN); Youteng FAN, Chengdu (CN); Sheng CAO, Chengdu (CN)

(73) Assignees: University of Electronic Science and Technology of China, Chengdu (CN); Sichuan Digital Economy Research Institute (Yibin), Yibin (CN)

(21) Appl. No.: 18/670,040

(22) Filed: May 21, 2024

(30) Foreign Application Priority Data
Feb. 4, 2024 (CN) 202410160114.6

(51) Int. Cl. G06N 3/092; G06N 3/0455

(52) U.S. Cl. CPC G06N 3/092; G06N 3/0455

(57) ABSTRACT

Provided are a reinforcement learning method and system based on sequential decision-making, a device, and a medium. The method includes: preprocessing historical trajectory data of reinforcement learning to generate preprocessed historical trajectory data to train a Transformer network model, and transforming the reinforcement learning into a language conversion model task by using a text conversion mechanism in the Transformer network model, to generate a trained Transformer network model, where the Transformer network model is used to predict action information at a next time point in a historical environment, and determine a maximum target reward value in a historical environmental state to obtain a complete trajectory in the historical environmental state; and predicting action information at the next time point in a real environmental state by using the trained Transformer network model, to obtain a complete trajectory in the real environmental state.

### CROSS-REFERENCE TO RELATED APPLICATION

This patent application claims the benefit and priority of Chinese Patent Application No. 2024101601146 filed with the China National Intellectual Property Administration on Feb. 4, 2024, the disclosure of which is incorporated by reference herein in its entirety as part of the present application.

### TECHNICAL FIELD

The present disclosure relates to the technical field of sequential decision-making, and in particular, to a reinforcement learning method and system based on sequential decision-making, a device, and a medium.

### BACKGROUND

Traditionally, reinforcement learning is trained through two kinds of method: policy-based learning and value function-based learning. In the case of a known environment (state transition probability or return), an optimal policy is directly solved through strategy iteration or value iteration. For a complex environment in which it is impossible to obtain all information, samples must be obtained through exploration, and this training process is usually updating a value function or a policy function. In recent years, a significant breakthrough has been made in natural speech processing and even in computer vision using a large-scale generative model, and related methods have also been introduced into reinforcement learning, such as Transformer.

In order to combine a relevant sequential prediction algorithm and the reinforcement learning, researchers treat a training task of the reinforcement learning as a sequential decision-making problem. At present, research on combination of a Transformer network model and the reinforcement learning mainly focuses on data processing, which simply processes data into a form suitable for being inputted into the model and then uses processed data for training to obtain a result. A traditional reinforcement learning algorithm uses a Markov decision process, which causes unstable training and a low-accuracy prediction result. A general model only processes reinforcement learning data into a training rule in accord with a language model, and then directly uses the training rule for training. Although an ideal result is obtained, a trained model is irrational and uninterpretable.

### SUMMARY

An objective of the present disclosure is to provide a reinforcement learning method and system based on sequential decision-making, a device, and a medium to solve a problem of a low-accuracy prediction result of a Transformer network model trained by using a traditional reinforcement learning algorithm and a lack of rationality and interpretability of a trained model.

To achieve the above objective, the present disclosure provides following technical solutions.

A reinforcement learning method based on sequential decision-making includes:
preprocessing historical trajectory data of reinforcement learning to generate preprocessed historical trajectory data, where the historical trajectory data is generated by agents with different training degrees during gameplay testing in a simulated game environment; and the preprocessed historical trajectory data includes state information at any time, action information at any time, and instant target reward information at any time;
training a Transformer network model based on the preprocessed historical trajectory data, and transforming the reinforcement learning into a language conversion model task by using a text conversion mechanism in the Transformer network model, to generate a trained Transformer network model, where the Transformer network model includes an input/output-end encoding module, a position information encoding module, a network mask design module, an encoder module, a decoder module, and a linear layer; and the Transformer network model is used to predict action information at a next time point in a historical environment, and determine a maximum target reward value in a historical environmental state to obtain a complete trajectory in the historical environmental state; and
predicting action information at the next time point in a real environmental state by using the trained Transformer network model, to obtain a complete trajectory in the real environmental state.

In this embodiment, the preprocessing historical trajectory data of reinforcement learning to generate preprocessed historical trajectory data includes:
processing the historical trajectory data of the reinforcement learning to form sequential trajectory data containing contextual information; and
segmenting the sequential trajectory data to generate the preprocessed historical trajectory data.

In this embodiment, the training a Transformer network model based on the preprocessed historical trajectory data, and transforming the reinforcement learning into a language conversion model task by using a text conversion mechanism in the Transformer network model, to generate a trained Transformer network model includes:
encoding the preprocessed historical trajectory data by using the input/output-end encoding module, to generate encoded historical trajectory data;
embedding positional encoding information into the encoded historical trajectory data by using the position information encoding module, to generate historical trajectory data containing the positional encoding information;
inserting a same network mask into the encoder module and the decoder module by using the network mask design module, to process the historical trajectory data containing the positional encoding information;
determining, by using the encoder module, global state information based on state information processed by the network mask and a total expected target reward, where the total expected target reward is determined based on the instant target reward information;
determining undecoded action information by using the decoder module based on action information processed by the network mask and the global state information, where the undecoded action information is hidden action information; and
predicting the action information at the next time point in the historical environment by using the linear layer based on the undecoded action information to obtain the complete trajectory in the historical environmental state.

A reinforcement learning system based on sequential decision-making includes:
a preprocessing module, configured to preprocess historical trajectory data of reinforcement learning to generate preprocessed historical trajectory data, where the historical trajectory data is generated by agents with different training degrees during gameplay testing in a simulated game environment; and the preprocessed historical trajectory data includes state information at any time, action information at any time, and instant target reward information at any time;
a training module, configured to train a Transformer network model based on the preprocessed historical trajectory data, and transform the reinforcement learning into a language conversion model task by using a text conversion mechanism in the Transformer network model, to generate a trained Transformer network model, where the Transformer network model includes an input/output-end encoding module, a position information encoding module, a network mask design module, an encoder module, a decoder module, and a linear layer; and the Transformer network model is used to predict action information at a next time point in a historical environment, and determine a maximum target reward value in a historical environmental state to obtain a complete trajectory in the historical environmental state; and
a prediction module configured to predict action information at the next time point in a real environmental state by using the trained Transformer network model, to obtain a complete trajectory in the real environmental state.

In this embodiment, the training module includes:
the input/output-end encoding module, configured to encode the preprocessed historical trajectory data to generate encoded historical trajectory data;
the position information encoding module, configured to embed positional encoding information into the encoded historical trajectory data to generate historical trajectory data containing the positional encoding information;
the network mask design module, configured to insert a same network mask into the encoder module and the decoder module to process the historical trajectory data containing the positional encoding information;
the encoder module, configured to determine global state information based on state information processed by the network mask and a total expected target reward, where the total expected target reward is determined based on the instant target reward information;
the decoder module, configured to determine undecoded action information based on action information processed by the network mask and the global state information, where the undecoded action information is hidden action information; and
the linear layer, configured to predict the action information at the next time point in the historical environment based on the undecoded action information to obtain the complete trajectory in the historical environmental state.

In this embodiment, the encoder module includes six encoder structures stacked together; and
the encoder structure includes a first attention mechanism layer, a first normalization layer, a first feedforward neural network layer, and a second normalization layer based on an order of inputting the state information processed by the network mask and the total expected target reward into the encoder structure.

In this embodiment, the decoder module includes six decoder structures stacked together; and
the decoder structure includes a second attention mechanism layer, a third normalizing a layer, a third attention mechanism layer, a fourth normalization layer, a second feedforward neural network layer, and a fifth normalization layer based on an order of inputting the action information processed by the network mask and the global state information into the decode structure.

In this embodiment, the network mask is an upper triangular matrix.

An electronic device includes a memory and a processor, where the memory is configured to store a computer program, and the processor runs the computer program to enable the electronic device to execute the foregoing reinforcement learning method based on sequential decision-making.

A computer-readable storage medium stores a computer program, where the computer program is executed by a processor to execute the foregoing reinforcement learning method based on sequential decision-making.

According to specific embodiments provided in the present disclosure, the present disclosure achieves following technical effects: a Transformer network model is trained based on existing historical trajectory data, a relationship between a target reward and a trajectory is learned from the Transformer network model to obtain a sequence of the target reward, thereby generating a corresponding trajectory based on an target reward set artificially to obtain a maximum target reward value in a current environment, and predict action information at a next time point in a historical environment, and thus obtaining a complete trajectory in a historical environmental state, such that a reinforcement learning task is completed. By setting the target reward information, it avoids unstable training caused by use of a Markov decision process in a traditional reinforcement learning algorithm, and improves accuracy of a prediction result of the Transformer network model.

In the present disclosure, a text conversion mechanism in the Transformer network model is used to transform reinforcement learning into a language conversion model task, thereby making the Transformer network model more interpretable and providing a new idea for combining the reinforcement learning and a related language model.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a flowchart of a reinforcement learning method based on sequential decision-making according to the present disclosure;

FIG. 2 is a schematic diagram of an input/output-end encoding module according to the present disclosure;

FIG. 3 is a schematic diagram of a position information encoding module according to the present disclosure;

FIG. 4 is a schematic diagram of a network mask design module according to the present disclosure;

FIG. 5 is a schematic diagram of a training process by using a network mask according to the present disclosure;

FIG. 6 is an overall architectural diagram of an Actions-Translator Transformer (ATT) according to the present disclosure;

FIG. 7 is a schematic diagram of an encoder module according to the present disclosure;

FIG. 8 is a schematic diagram of a decoder module according to the present disclosure; and

FIG. 9 is a schematic diagram of an action prediction output module according to the present disclosure.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

An objective of the present disclosure is to provide a reinforcement learning method and system based on sequential decision-making, a device, and a medium, which can improve accuracy of a prediction result of a Transformer network model and make the Transformer network model more interpretable.

In order to make the above objective, features, and advantages of the present disclosure clearer and more comprehensible, the present disclosure will be further described in detail below in combination with accompanying drawings and particular implementations.

### Embodiment 1

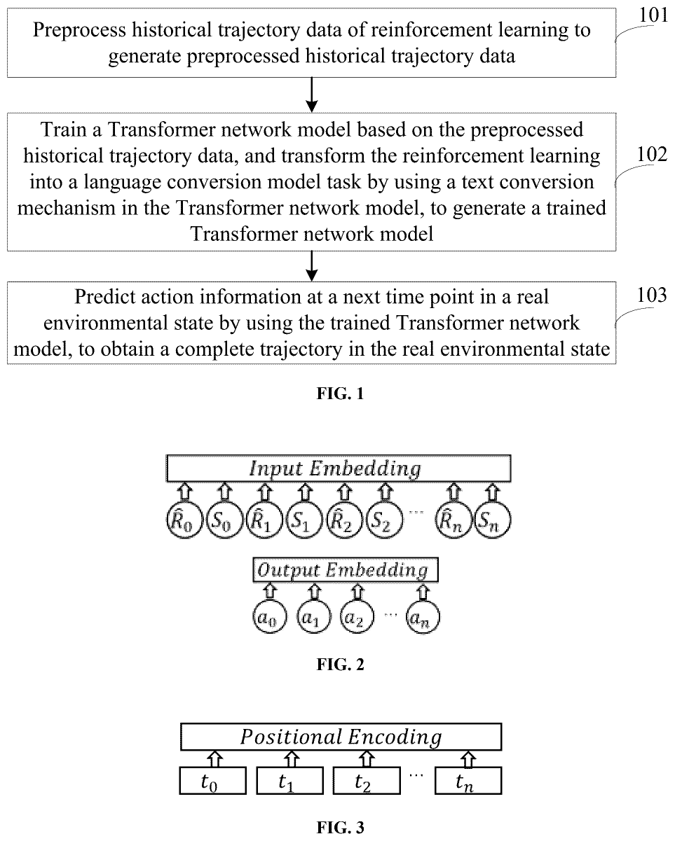

As shown in FIG. 1, a reinforcement learning method based on sequential decision-making in the present disclosure includes Steps 101 to 103:

In Step 101: historical trajectory data of reinforcement learning is preprocessed to generate preprocessed historical trajectory data, where the historical trajectory data is generated by agents with different training degrees during gameplay testing in a simulated game environment; and the preprocessed historical trajectory data includes state information at any time, action information at any time, and instant target reward information at any time.

In an actual application, the step 101 specifically includes: processing the historical trajectory data of the reinforcement learning to form sequential trajectory data containing contextual information; and segmenting the sequential trajectory data to generate the preprocessed historical trajectory data.

In an actual application, a format of training data needs to be processed first. Historical data of traditional reinforcement learning cannot be directly applied to a sequential model of the present disclosure for learning. It is necessary to establish a connection between the data first and cut the data into data with a length suitable for a Transformer network to learn. This step mainly involves data preprocessing to make experimental data of the traditional reinforcement learning suitable for a designed sequential decision-making network.
1) Historical trajectory data for the reinforcement learning, encapsulated in a D4RL package of Python software, is used. This data is the historical trajectory data generated by the agents with the different training degrees during the gameplay testing in the simulated game environment. A specific game scenario for gameplay is a series of small games included in a Gym package of the Python software, such as games in Atari, MuJoCo, and other environments. Following four types of data are mainly included:

Medium dataset: A policy network is trained online by using Soft Actor Critic, and the training is terminated early. In this case, the medium dataset is generated by collecting 1M samples from such partially trained policy.

Random dataset: The random dataset is obtained by generating an initialization policy randomly.

Medium-replay dataset: The medium-replay dataset includes all samples recorded in a replay buffer observed during the training until the policy reaches a “medium” performance level.

Medium-expert dataset: The medium-expert dataset is further introduced by mixing equal amounts of expert demonstration data and suboptimal data. Data in the medium-expert dataset is generated by using the partially trained policy or by unfolding a uniform random policy.

These four types of data can effectively cover the field in which the model can be tested, and evaluate advantages and disadvantages of the model.
2) The data is processed to establish the connection between the data, thereby forming the sequential trajectory data containing the contextual information. Original trajectory data is represented in a following form:

$$τ = ( … , {s}_{t - 1} , {a}_{t - 1} , {r}_{t - 1} , {s}_{t} , {a}_{t} , {r}_{t} , {s}_{t + 1} , {a}_{t + 1} , {r}_{t + 1} , … ) .$$

In the above equation, s represents state information at a certain time point, a represents action information at a certain time point, and r represents instant reward information at a certain time point. Such trajectory data can only represent relevant information at each time point and cannot be used as training data for a Transformer model to perform contextual relation learning. Therefore, the data needs to be processed. Specifically, forms of the s and the a in the original trajectory data are retained, and the r is processed to form a new form \hat{R}, which is calculated as follows:

$${\hat{R}}_{t} = {r}_{t} + {r}_{t + 1} + {r}_{t + 2} + … + {r}_{end} .$$

In this case, information represented by the \hat{R}ₜ is a total reward value that can be obtained from a current time point to an end of a trajectory, such that a connection between data at different time points is established. Historical data of the trajectory is processed and transformed into a following form:

\hat{τ}=(\hat{R}₀,s₀,a₀,\hat{R}₁,s₁,a₁, . . . ,\hat{R}ₜ,sₜ,aₜ).
3) The trajectory data is segmented. The Transformer model is a language model that utilizes contextual information, and can only process data of a limited length. Therefore, the trajectory data needs to be processed into data with a length K acceptable for the model, in other words, the original trajectory is processed into data segments with the length of K. Some data with an insufficient length is completed by filling unfilled (K−n) positions with zeros.

In Step 102, the Transformer network model is trained based on the preprocessed historical trajectory data, and the reinforcement learning is transformed into a language conversion model task by using a text conversion mechanism in the Transformer network model, to generate a trained Transformer network model, where the Transformer network model includes an input/output-end encoding module, a position information encoding module, a network mask design module, an encoder module, a decoder module, and a linear layer. The Transformer network model is used to predict action information at a next time point in a historical environment, and determine a maximum target reward value in a historical environmental state to obtain a complete trajectory in the historical environmental state.

In an actual application, the step 102 specifically includes: encoding the preprocessed historical trajectory data by using the input/output-end encoding module, to generate encoded historical trajectory data; embedding positional encoding information into the encoded historical trajectory data by using the position information encoding module, to generate historical trajectory data containing the positional encoding information; inserting a same network mask into the encoder module and the decoder module by using the network mask design module, to process the historical trajectory data containing the positional encoding information; determining, by using the encoder module, global state information based on state information processed by the network mask and a total expected target reward, where the total expected target reward is determined based on instant target reward information; determining undecoded action information by using the decoder module based on action information processed by the network mask and the global state information, where the undecoded action information is hidden action information; and predicting the action information at the next time point in the historical environment by using the linear layer based on the undecoded action information to obtain the complete trajectory in the historical environmental state.

In some applications, a network structure design part of the Transformer network model mainly includes network structure design, mask design, and positional encoding information design. This section mainly introduces an overall architecture of the network model as a basis for subsequent training and testing.

### 1) Data Encoding

Firstly, it is necessary to encode data segmented in the step 3) of the step 101. The state s, the action a, and the total expected target reward R are encoded directly using a fully connected layer. At an encoder end, a sequence composed of the R and the s is encoded, in other words, the sequence is input into an Input Embedding layer of the model. At a decoder end, a sequence composed of the a is encoded, in other words, the sequence is input into an Output Embedding layer of the model. Both the Input Embedding layer and the Output Embedding layer are fully connected layers, As shown in FIG. 2.

### 2) Position Information

Because the position information needs to be introduced in a training process of the Transformer network model, information of front and rear positions needs to be introduced based on an original code, which is superior to time point information inherent in the trajectory data of the reinforcement learning. Therefore, a time point of the data in the trajectory can be directly encoded as the position information, as shown in FIG. 3.

After the position information is encoded, a position information code of each time point is directly added up to codes of an input and an output that are obtained in the previous step. This step is intended to embed the position information into the training data, making it easier for the model to learn causal sequence information of the entire trajectory, namely a state transition relationship between different time nodes and reward change information between different time nodes.

### 3) Network Mask Design

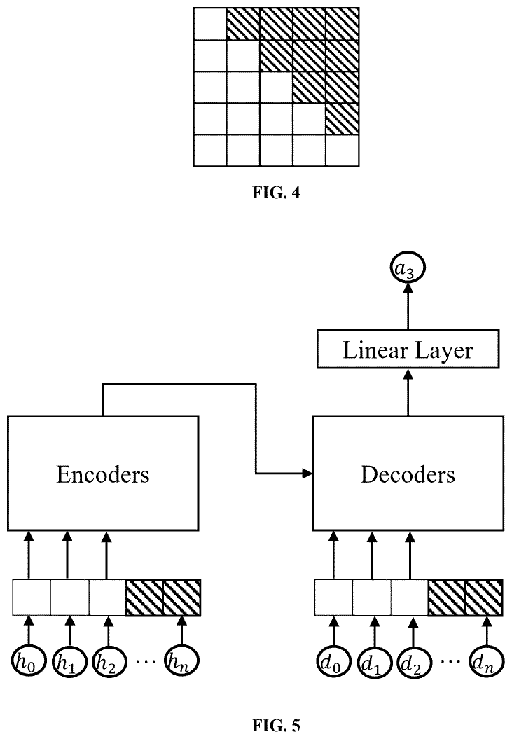

Data owned by the model in a training stage is complete data information of a trajectory. However, in a testing stage of the reinforcement learning, an action is executed from a certain time point to deduce trajectory generation, and as a result, global trajectory information cannot be observed. In order to align upstream and downstream tasks in the training and testing stages, a mask mechanism needs to be introduced to align the corresponding tasks. A mask with a structure of an upper triangular matrix needs to be inserted at both the encoder end and the decoder end, which only exposes historical data information before a current time point for a prediction task at the current time point, as shown in FIG. 4.

In the training process, a same mask is used at the encoder end and the decoder end, namely the upper triangular matrix shown in FIG. 4. Specific use of the mask in the training process is shown in FIG. 5. Due to use of Teacher-forcing, a multi-dimensional parallel training method, only a training method for a single dimension in the Teacher-forcing is displayed. A specific process is shown FIG. 5:

As shown in FIG. 5, h₀, h₁, . . . , hₙ represents processed input data of the encoder end after the position information is introduced in the step 2) of the step 102, and d₀, d₁, . . . , dₙ represents processed input data of the decoder end. After mask processing, input data for a next step only contains information before a time point t₂. After processed by an encoder and a decoder, known information is finally decoded by the linear layer, and thus obtaining action information a₃ at a time point t₃ through prediction, namely action information at a next time point of an observable time point. With the mask mechanism, the model can train data by ways of matrix, at a plurality of time points and in a multi-dimensional parallel manner, thereby accelerating a training speed. Meanwhile, the use of mask at the decoder end aligns task types in the training and testing stages. Because a complete sequence of future actions cannot be determined in the testing stage, task alignment can improve performance of the model in the testing stage.

### 4) Overall Model Architecture

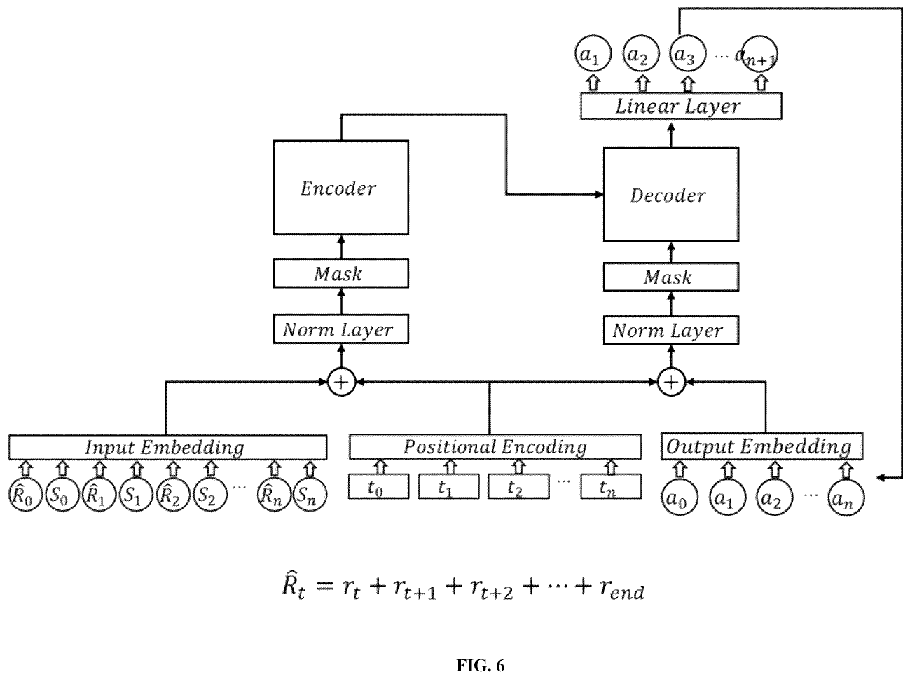

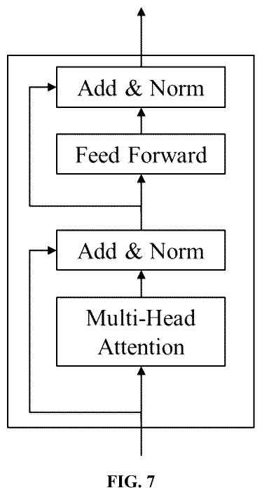

The model overall adopts a sequence-to-sequence form, including the encoder end and the decoder end. The encoder end, composed of six encoder structures stacked together, receives global environmental information (s, \hat{R}) which has been encoded and masked, and outputs a result to the decoder end. The decoder, composed of six decoder structures stacked together and mainly used to perform action prediction and learning, receives sequence information of the action a which has been encoded and masked, and predicts a next action based on an observable action and the global environmental information input by the encoder end to complete a decision-making process of the reinforcement learning. This section is an overall framework of an ATT model of the reinforcement learning. The ATT model adopts an architecture of the transformer model, which includes the encoder end, the decoder end, and a corresponding encoding structure. Data is input into the encoder end and decoder end from an initial encoding module and finally decoded through the linear layer at the decoder end to output an action prediction result, as shown in FIG. 6.

Step 103: action information at the next time point in a real environmental state is predicted by using the trained Transformer network model, to obtain a complete trajectory in the real environmental state.

In an actual application, the training and testing process of the Transformer network model includes a training process in which the model learns internal implicit correlation information from the historical trajectory data information and a process in which the Transformer network model derives a complete trajectory in the real environmental state.

### 1) Training Process of the Transformer Network Model

In the training process of the Transformer network model, the teacher-forcing training method is mainly adopted. The training process is as follows:
1-1) Original data are processed by using data clipping and encoding methods, to obtain outputs (\hat{R}, s) and a, where the (\hat{R}, s) represents the global environmental information, the \hat{R} represents the total expected target reward, and the a represents the action information.
1-2) The output (\hat{R}, s) in the previous step is processed by using the mask of the encoder end to obtain an output (\hat{R}, s)ₘₐₛₖ, and the output a in the previous step is processed by using the mask of the decoder end to obtain an output aₘₐₛₖ, where the (\hat{R}, s)ₘₐₛₖ represents the state information processed by the network mask and the total expected target reward processed by the network mask, and the aₘₐₛₖ represents the action information processed by the network mask.
1-3) The (\hat{R}, s)ₘₐₛₖ is inputted into stacked encoders to output global state information stateₐₗₗ.

1-4) The output aₘₐₛₖ obtained in the step 1-2) and the output stateₐₗₗ obtained in the step 1-3) is inputted together into stacked decoder Decoders to output undecoded action information a_{hide}.
1-5) The output a_{hide} obtained in the previous step is decoded by using a single linear network layer, to output a predicted action a_{pred}.

The training process is as follows:
Train:
change the r into \hat{R}: \hat{R}ₜ=rₜ+rₜ₊₁+rₜ₊₂+ . . . +r_{end},
encoding: encode the (\hat{R}, s) and a as a specified dimension dim;
embed the position information code and input into the encoder end as global information: (\hat{R}, s)+Position embedding→Encoders;
encode the a, embed the position information into an encoded a, and input into the decoder end:
   a+Position embedding→Decoders;
training.

In the above training process, the \hat{R}ₜ represents a total expected target reward at a time point t; the r_{end} represents a total expected target reward at an end time point, end=1, 2, 3 . . . , t, t+1, t+2 . . . ; the Position embedding represents the position information encoding module; the Encoders represents a plurality of encoders, and the Decoders represents a plurality of decoders.

A specific training method is as follows: Firstly, the data needs to be preprocessed according to the data processing method mentioned previously. Then, the state s and the total expected reward \hat{R} are input into the encoder end as globally observable information, and the a is input into the decoder end as a sequence to be predicted and generated, to calculate historical action information and a loss function. An expression L_{a,a}_{_{pred}} of the loss function is as follows:

$${L}_{a , {a}_{pred}} = \frac{1}{n} {\sum }_{i = 1}^{n} {( {a}_{pred} - a )}^{2} .$$

In the above expression, n represents a length of a sequence input into the model, a represents true value of an action, and a_{pred} represents a predicted value of the action output by the model.

The globally observable information is processed through the mask and the six encoder structures. Specifically, the input data is sequentially processed by attention mechanism layers and feedforward neural network layers in the encoder structures, and a normalization layer (Add&Norm) is inserted to prevent gradient explosion in the training process. An internal structure of each encoder is shown in FIG. 7.

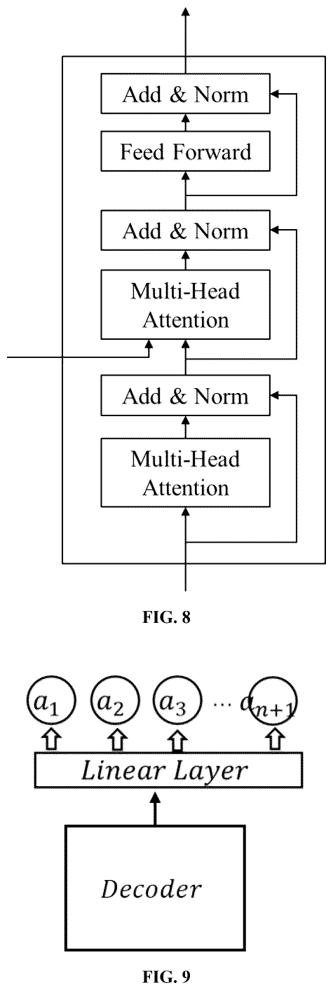

The global state information output by the decoder module is transmitted into the decoder end. The decoder end processes the global state information by using the six decoder structures based on an observable historical action sequence and observable global state information. A specific processing method is similar to that of the encoder module. The decoder module includes a multi-head attention mechanism and a feedforward neural network; and its difference from the encoder module is that the decoder module needs to receive an output of the encoder module, so an additional attention mechanism layer needs to be inserted in a structure of the decoder module. The structure of the decoder module is shown in FIG. 8.

A finally obtained result is input into a decoding structure to obtain a predicted next action. The action prediction output module is shown in FIG. 9. Afterwards, a loss is calculated based on an input and an output of the decoder end of the model to optimize the network model.

### 2) Inference Process of the Transformer Network Model

In the inference process of the Transformer network model, a self-regression method is mainly adopted. That is to say, in each prediction, a prediction result will be used as input information of a next prediction. By analogy, initial information set by a user is used for continuous inference to obtain a complete piece of trajectory information, which is the finally obtained complete trajectory.

The inference process is as follows:
Inference:

initialize \hat{R}₀: The \hat{R}₀ represents an artificially predicted maximum reward that may be obtained in an environment;

initializing s₀
initialize an action a₋₁ by the decoder end, and then input to the decoder end after padding;
predict the a;
execute the a (perform state transition to obtain the r, s);
update the \hat{R}: \hat{R}ₜ→\hat{R}ₜ₋₁−rₜ₋₁;
add sₜ to the sequence;
repeat the above operations till the sequence ends.

In the above inference process, the s₀ represents state information at an initial time point, the r represents the instant reward information, and the sₜ represents state information at the time point t.

A specific inference method is as follows: as the model needs to use the initial information \hat{R} and the total expected total reward, the maximum reward value \hat{R}₀ that can be obtained in the environment is artificially set based on priori knowledge (an ultimate goal of the reinforcement learning is to obtain a maximum reward in the current environment). Initial information of the environment can be directly obtained through environment initialization. The action information a₋₁ is initialized at the decoder end, all the above information is completed through filling bit and then input into the encoder end and the decoder end according to an input method in the training process.

Similarly, the \hat{R} and the s are input into the encoder end as the globally observable information, and then input into the decoder end after being processed by the mask and the six encoder structures. At the decoder end, the next action is directly predicted based on the historical action information and the globally observable information.

After the model outputs the next action aₜ, the aₜ will be executed in the current environment. At this time, the environmental information will change and the instant reward rₜ will also be obtained. The total expected total reward \hat{R}ₜ is updated based on the instant reward rₜ:

\hat{R}:\hat{R}ₜ₊₁→\hat{R}ₜ−rₜ.

The newly obtained aₜ, Rₜ₊₁, and sₜ₊₁ are embedded the existing sequence as observable data for predicting a next action. By analogy, a complete trajectory can be finally obtained based on the total expected reward \hat{R}₀ set artificially. Based on this trajectory, a total reward value that can be obtained from the inferred trajectory can be calculated, thereby evaluating the advantages and disadvantages of the model.

Compared with the prior art, the present disclosure has achieved a good result. In addition, in the research field of combining a language model and the reinforcement learning, interpretability of the model has always been an important issue. A general model only processes reinforcement learning data into a training rule of a composite language model, and then the training rule is directly used for training. Although an ideal result is obtained, the model is irrational and uninterpretable. In the present disclosure, a traditional reinforcement learning is transformed into a language conversion model task by using a text conversion mechanism in the language model, which makes the model more interpretable while achieving a good experimental result, and also provides a new idea for combining the reinforcement learning and a related language model. The experimental result is shown in Table 1.

TABLE 1
Comparison of the method (My) according to the present disclosure with
other offline reinforcement learning algorithms in Mujoco.

| Dataset | Environment | My | DT | CQL | BEAR | BRAC-v | AWR | BC |
|---|---|---|---|---|---|---|---|---|
| Medium-replay | Hopper | 79.3 | 82.7 | 48.6 | 33.7 | 0.6 | 28.4 | 27.6 |
| | Walker2D | 68.7 | 66.6 | 26.7 | 19.2 | 0.9 | 15.5 | 36.9 |
| | HalfCheetah | 36.3 | 36.6 | 46.2 | 38.6 | 47.7 | 40.3 | 4.3 |
| Medium | Hopper | 68.4 | 67.6 | 58.0 | 52.1 | 31.1 | 35.9 | 63.9 |
| | Walker2D | 82.0 | 74.0 | 79.2 | 59.1 | 81.1 | 17.4 | 77.4 |
| | HalfCheetah | 40.3 | 42.6 | 44.4 | 41.7 | 46.3 | 37.4 | 43.1 |
| Medium-expert | Hopper | 109.8 | 107.6 | 111.0 | 96.3 | 0.8 | 27.1 | 76.9 |
| | Walker2D | 110.2 | 108.1 | 98.7 | 40.1 | 81.6 | 53.8 | 36.6 |
| | HalfCheetah | 88.9 | 86.8 | 62.4 | 53.4 | 41.9 | 52.7 | 59.5 |

In order to achieve reinforcement learning based on sequential decision-making, the present disclosure designs a reinforcement learning decision-making model with greater interpretability and better performance, namely a Transformer network model. The Transformer network model can better introduce training methods related to reinforcement learning into a training process of the language model, thereby effectively solving a difficulty of combining a sequential decision-making task and the reinforcement learning, and providing a new idea for solving a Deadly Triad problem of the reinforcement learning.

### Embodiment 2

In order to perform the method in Embodiment 1 to achieve corresponding functions and technical effects, a reinforcement learning system based on sequential decision-making is provided below.

A reinforcement learning system based on sequential decision-making includes:
a preprocessing module, configured to preprocess historical trajectory data of reinforcement learning to generate preprocessed historical trajectory data, where the historical trajectory data is generated by agents with different training degrees during gameplay testing in a simulated game environment; and the preprocessed historical trajectory data includes state information at any time, action information at any time, and instant target reward information at any time;
a training module, configured to train a Transformer network model based on the preprocessed historical trajectory data, and transform the reinforcement learning into a language conversion model task by using a text conversion mechanism in the Transformer network model, to generate a trained Transformer network model, where the Transformer network model includes an input/output-end encoding module, a position information encoding module, a network mask design module, an encoder module, a decoder module, and a linear layer; and the Transformer network model is used to predict action information at a next time point in a historical environment, and determine a maximum target reward value in a historical environmental state to obtain a complete trajectory in the historical environmental state; and
a prediction module, configured to predict action information at the next time point in a real environmental state by using the trained Transformer network model, to obtain a complete trajectory in the real environmental state.

In some applications, the training module specifically includes the input/output-end encoding module, the position information encoding module, the network mask design module, the encoder module, the decoder module and the linear layer; the input/output-end encoding module is configured to encode the preprocessed historical trajectory data to generate encoded historical trajectory data; the position information encoding module is configured to embed positional encoding information into the encoded historical trajectory data to generate historical trajectory data containing the positional encoding information; the network mask design module is configured to insert a same network mask into the encoder module and the decoder module to process the historical trajectory data containing the positional encoding information; the encoder module is configured to determine global state information based on state information processed by the network mask and a total expected target reward, where the total expected target reward is determined based on instant target reward information; the decoder module is configured to determine undecoded action information based on action information processed by the network mask and the global state information, where the undecoded action information is hidden action information; and the linear layer is configured to predict the action information at the next time point in the historical environment based on the undecoded action information to obtain the complete trajectory in the historical environmental state.

In some applications, the encoder module includes six encoder structures stacked together; and the encoder structure includes a first attention mechanism layer, a first normalization layer, a first feedforward neural network layer, and a second normalization layer based on an order of inputting the state information processed by the network mask and the total expected target reward into the encoder structure.

In some applications, the decoder module includes six decoder structures stacked together; and the decoder structure includes a second attention mechanism layer, a third normalizing a layer, a third attention mechanism layer, a fourth normalization layer, a second feedforward neural network layer, and a fifth normalization layer based on an order of inputting the action information processed by the network mask and the global state information into the decode structure.

In some applications, the network mask is an upper triangular matrix.

### Embodiment 3

An electronic device includes a memory and a processor, where the memory is configured to store a computer program, and the processor runs the computer program to enable the electronic device to execute the foregoing reinforcement learning method based on sequential decision-making.

A computer-readable storage medium stores a computer program, where the computer program is executed by a processor to execute the foregoing reinforcement learning method based on sequential decision-making.

The present disclosure provides a new reinforcement learning sequential decision-making model, i.e., ATT model, which is applied to a task of generating a sequential trajectory of the reinforcement learning. In the present disclosure, according to existing historical trajectory data, a relationship between a target reward and a trajectory can be learned from the existing historical trajectory data, and similarly, a sequence from which the target reward is obtained is learned from it, thereby generating a corresponding trajectory based on a target reward value set artificially, and thus obtaining a maximum target reward value in a current environment, and completing a reinforcement learning task. Meanwhile, the present disclosure can avoid unstable training caused by use of a Markov decision process in a traditional reinforcement learning algorithm. This solution is mainly applied to a reinforcement learning task in a virtual game environment, and can also be extended to an actual production environment that is easy to collect historical operational data, thereby providing a new training method and idea for training agents that meets human requirements.

Each embodiment in the specification is described in a progressive mode, each embodiment focuses on differences from other embodiments, and references can be made to each other for the same and similar parts between the embodiments. Since the system disclosed in an embodiment corresponds to the method disclosed in an embodiment, the description is relatively simple, and for related contents, references can be made to the description of the method.

Particular examples are used herein for illustration of principles and implementations of the present disclosure. The descriptions of the above embodiments are merely used for assisting in understanding the method of the present disclosure and its core ideas. In addition, those of ordinary skill in the art can make various modifications in terms of particular implementations and the scope of application in accordance with the ideas of the present disclosure. In conclusion, the content of the specification shall not be construed as limitations to the present disclosure.

What is claimed is:

1. A reinforcement learning method based on sequential decision-making, comprising:
preprocessing historical trajectory data of reinforcement learning to generate preprocessed historical trajectory data, wherein the historical trajectory data is generated by agents with different training degrees during gameplay testing in a simulated game environment; and the preprocessed historical trajectory data comprises state information at any time, action information at any time, and instant target reward information at any time;
training a Transformer network model based on the preprocessed historical trajectory data, and transforming the reinforcement learning into a language conversion model task by using a text conversion mechanism in the Transformer network model, to generate a trained Transformer network model, wherein the Transformer network model comprises an input/output-end encoding module, a position information encoding module, a network mask design module, an encoder module, a decoder module, and a linear layer; and the Transformer network model is used to predict action information at a next time point in a historical environment, and determine a maximum target reward value in a historical environmental state to obtain a complete trajectory in the historical environmental state; and
predicting action information at the next time point in a real environmental state by using the trained Transformer network model, to obtain a complete trajectory in the real environmental state.

2. The method according to claim 1, wherein the preprocessing historical trajectory data of reinforcement learning to generate preprocessed historical trajectory data comprises:
processing the historical trajectory data of the reinforcement learning to form sequential trajectory data containing contextual information; and
segmenting the sequential trajectory data to generate the preprocessed historical trajectory data.

3. The method according to claim 1, wherein the training a Transformer network model based on the preprocessed historical trajectory data, and transforming the reinforcement learning into a language conversion model task by using a text conversion mechanism in the Transformer network model, to generate a trained Transformer network model comprises:
encoding the preprocessed historical trajectory data by using the input/output-end encoding module, to generate encoded historical trajectory data;
embedding positional encoding information into the encoded historical trajectory data by using the position information encoding module, to generate historical trajectory data containing the positional encoding information;
inserting a same network mask into the encoder module and the decoder module by using the network mask design module, to process the historical trajectory data containing the positional encoding information;
determining, by using the encoder module, global state information based on state information processed by the network mask and a total expected target reward, wherein the total expected target reward is determined based on the instant target reward information;
determining undecoded action information by using the decoder module based on action information processed by the network mask and the global state information, wherein the undecoded action information is hidden action information; and
predicting the action information at the next time point in the historical environment by using the linear layer based on the undecoded action information to obtain the complete trajectory in the historical environmental state.

4. A reinforcement learning system based on sequential decision-making, comprising:
a preprocessing module, configured to preprocess historical trajectory data of reinforcement learning to generate preprocessed historical trajectory data, wherein the historical trajectory data is generated by agents with different training degrees during gameplay testing in a simulated game environment; and the preprocessed historical trajectory data comprises state information at any time, action information at any time, and instant target reward information at any time;
a training module, configured to train a Transformer network model based on the preprocessed historical trajectory data, and transform the reinforcement learning into a language conversion model task by using a text conversion mechanism in the Transformer network model, to generate a trained Transformer network model, wherein the Transformer network model comprises an input/output-end encoding module, a position information encoding module, a network mask design module, an encoder module, a decoder module, and a linear layer; and the Transformer network model is used to predict action information at a next time point in a historical environment, and determine a maximum target reward value in a historical environmental state to obtain a complete trajectory in the historical environmental state; and
a prediction module configured to predict action information at the next time point in a real environmental state by using the trained Transformer network model, to obtain a complete trajectory in the real environmental state.

5. The system according to claim 4, wherein the training module comprises:
the input/output-end encoding module, configured to encode the preprocessed historical trajectory data to generate encoded historical trajectory data;
the position information encoding module, configured to embed positional encoding information into the encoded historical trajectory data to generate historical trajectory data containing the positional encoding information;
the network mask design module, configured to insert a same network mask into the encoder module and the decoder module to process the historical trajectory data containing the positional encoding information;
the encoder module, configured to determine global state information based on state information processed by the network mask and a total expected target reward, wherein the total expected target reward is determined based on the instant target reward information;
the decoder module, configured to determine undecoded action information based on action information processed by the network mask and the global state information, wherein the undecoded action information is hidden action information; and
the linear layer, configured to predict the action information at the next time point in the historical environment based on the undecoded action information to obtain the complete trajectory in the historical environmental state.

6. The system according to claim 4, wherein the encoder module comprises six encoder structures stacked together; and
the encoder structure comprises a first attention mechanism layer, a first normalization layer, a first feedforward neural network layer, and a second normalization layer based on an order of inputting the state information processed by the network mask and the total expected target reward into the encoder structure.

7. The system according to claim 4, wherein the decoder module comprises six decoder structures stacked together; and
the decoder structure comprises a second attention mechanism layer, a third normalizing a layer, a third attention mechanism layer, a fourth normalization layer, a second feedforward neural network layer, and a fifth normalization layer based on an order of inputting the action information processed by the network mask and the global state information into the decode structure.

8. The system according to claim 4, wherein the network mask is an upper triangular matrix.

9. An electronic device, comprising a memory and a processor, wherein the memory is configured to store a computer program, and the processor runs the computer program to enable the electronic device to execute the reinforcement learning method based on sequential decision-making according to claim 1.

10. The electronic device according to claim 9, wherein the preprocessing historical trajectory data of reinforcement learning to generate preprocessed historical trajectory data comprises:
processing the historical trajectory data of the reinforcement learning to form sequential trajectory data containing contextual information; and
segmenting the sequential trajectory data to generate the preprocessed historical trajectory data.

11. The electronic device according to claim 9, wherein the training a Transformer network model based on the preprocessed historical trajectory data, and transforming the reinforcement learning into a language conversion model task by using a text conversion mechanism in the Transformer network model, to generate a trained Transformer network model comprises:
encoding the preprocessed historical trajectory data by using the input/output-end encoding module, to generate encoded historical trajectory data;
embedding positional encoding information into the encoded historical trajectory data by using the position information encoding module, to generate historical trajectory data containing the positional encoding information;
inserting a same network mask into the encoder module and the decoder module by using the network mask design module, to process the historical trajectory data containing the positional encoding information;
determining, by using the encoder module, global state information based on state information processed by the network mask and a total expected target reward, wherein the total expected target reward is determined based on the instant target reward information;
determining undecoded action information by using the decoder module based on action information processed by the network mask and the global state information, wherein the undecoded action information is hidden action information; and
predicting the action information at the next time point in the historical environment by using the linear layer based on the undecoded action information to obtain the complete trajectory in the historical environmental state.

12. A computer-readable storage medium, wherein the computer-readable storage medium stores a computer program, and the computer program is executed by a processor to execute the reinforcement learning method based on sequential decision-making according to claim 1.

13. The computer-readable storage medium according to claim 12, wherein the preprocessing historical trajectory data of reinforcement learning to generate preprocessed historical trajectory data comprises:
processing the historical trajectory data of the reinforcement learning to form sequential trajectory data containing contextual information; and
segmenting the sequential trajectory data to generate the preprocessed historical trajectory data.

14. The computer-readable storage medium according to claim 12, wherein the training a Transformer network model based on the preprocessed historical trajectory data, and transforming the reinforcement learning into a language conversion model task by using a text conversion mechanism in the Transformer network model, to generate a trained Transformer network model comprises:
encoding the preprocessed historical trajectory data by using the input/output-end encoding module, to generate encoded historical trajectory data;
embedding positional encoding information into the encoded historical trajectory data by using the position information encoding module, to generate historical trajectory data containing the positional encoding information;
inserting a same network mask into the encoder module and the decoder module by using the network mask design module, to process the historical trajectory data containing the positional encoding information;
determining, by using the encoder module, global state information based on state information processed by the network mask and a total expected target reward, wherein the total expected target reward is determined based on the instant target reward information;
determining undecoded action information by using the decoder module based on action information processed by the network mask and the global state information, wherein the undecoded action information is hidden action information; and
predicting the action information at the next time point in the historical environment by using the linear layer based on the undecoded action information to obtain the complete trajectory in the historical environmental state.
